(19) United States
(12) Patent Application Publication
(10) Pub. No.: US 2011/0287185 A1
(43) Pub. Date: Nov. 24, 2011

(54) Adaptive Manufacturing Device and Method

(76) Inventors: Michael W. Felstead, Devon (GB); Neil T. Sewell, Devon (GB)

(21) Appl. No.: 13/130,743

(22) PCT Filed: Nov. 24, 2009
(86) PCT No.: PCT/GB2009/002730

§ 371 Date: Aug. 1, 2011

(30) Foreign Application Priority Data
Nov. 27, 2008 (GB) 0821660.8

(51) Int. Cl. B05D 3/12; B05D 1/42; B05C 11/02

(52) U.S. Cl. 427/277; 118/58; 118/56

(57) ABSTRACT

Various devices, systems and methods for manufacturing are discussed. For example, a manufacturing device is discussed that includes a hopper/wiper device operable to apply layers of material to a bed, and heater means operable to heat selected areas of each layer to form a product. The hopper/wiper device is operable so that the product includes at least a first part of a first material or material blend and a second part of a second material or material blend.

### CROSS REFERENCE TO RELATED APPLICATION

This application is the United States national stage filing of PCT/GB2009/002730 entitled “Adaptive Manufacturing Device and Method” and filed Nov. 24, 2009; which claims priority to Great Britain Patent Application GB0821660.8 entitled “Adaptive Manufacturing Device and Method” and filed Nov. 27, 2008. Both of the aforementioned applications are incorporated herein by reference for all purposes.

### BACKGROUND OF THE INVENTION

This invention relates to a manufacturing device, and in particular to a device for use in an additive layer manufacturing technique, for example for use in the rapid manufacture of products or for use in rapid prototyping. It also relates to an associated manufacturing method.

Additive layer manufacturing techniques are well known in the rapid manufacture of prototypes, and it is increasingly desirable to use such techniques in the rapid manufacture of products, for example the component parts of machines. It is thought that such techniques could be used in the manufacture of spare parts for machines, engines or the like to permit maintenance, servicing or repair thereof without requiring a large number of spare parts to be carried in stock.

A number of additive layer manufacturing techniques are known. For example, one technique involves applying a uniform thickness layer of a powdered material to a bed, and then using a laser to heat and melt parts of the layer. The bed is then lowered and another layer of material applied thereto. Again, parts of the layer are heated. The process is repeated many times, after which the finished product, composed of these parts of the layers which have been heated, is removed from the bed, the parts of the layers that have not been heated remaining in powder form and so being relatively easy to remove from the finished product.

For various reasons, there exists a need in the art for advanced systems and methods for manufacturing.

### BRIEF DESCRIPTION OF THE DRAWINGS

The invention will further be described, by way of example, with reference to the accompanying drawings, in which:

FIG. 1 is a diagram illustrating a device in accordance with one embodiment of the invention;

FIG. 1a is an enlarged view of part of the device of FIG. 1;

FIG. 2 is a view illustrating a modification to the arrangement of FIG. 1;

FIG. 3 is a diagram illustrating an alternative device; and

FIG. 4 is a diagram illustrating a further embodiment of the invention.

### BRIEF SUMMARY OF THE INVENTION

This invention relates to a manufacturing device, and in particular to a device for use in an additive layer manufacturing technique, for example for use in the rapid manufacture of products or for use in rapid prototyping. It also relates to an associated manufacturing method.

According to one aspect of the invention there is provided a manufacturing device comprising a hopper/wiper device operable to apply layers of material to a bed, and heater means operable to heat selected areas of each layer to form a product, wherein the hopper/wiper device is operable so that the product includes at least a first part of a first material or material blend and a second part of a second material or material blend.

It will be appreciated that such an arrangement is advantageous in that the range of products which can be manufactured is significantly increased, as, for example, different parts of the product may have different hardnesses or other characteristics.

In one arrangement, the hopper/wiper device is operable to permit control over the material or material blend of each layer. For example, the hopper/wiper device may comprise a delivery hopper, at least first and second storage hoppers, and delivery means associated with each storage hopper to deliver a controllable quantity of material therefrom to the delivery hopper. It will be appreciated that by appropriate control over the delivery means, the blend of material in the delivery hopper can be controlled.

A mixing hopper may be interposed between the storage hoppers and the delivery hopper to assist in ensuring full mixing of the material.

The delivery means conveniently comprises a rotatable shaft in which pockets are formed, and drive means operable to rotate the shaft. The drive means preferably comprises a stepper motor. The pockets may comprise elongate grooves formed in the shaft.

In an alternative arrangement, different parts of some of the layers may be formed from different materials. For example, the hopper/wiper may comprise a hopper movable to deliver a layer of a first material, and means operable to remove the first material and introduce a second material in its place. The hopper is conveniently movable in a first direction, and the removing and introducing means may be carried by the hopper and movable relative thereto in a second, perpendicular direction.

The first material may be removed using a vacuum removal technique. Alternatively, it may be removed mechanically, for example by scraping. An Archimedes screw arrangement may be used in the introduction of the second material. Such an arrangement permits accurate control over the quantity of second material delivered.

The invention also relates to an additive layer manufacturing method comprising applying a layer of a first material, removing the first material from selected areas of the layer and replacing the removed material with a second material.

According to another aspect of the invention there is provided an additive layer manufacturing device comprising a hopper/wiper device operable to deliver a layer of material, and a compaction device operable to compact the layer of material delivered by the hopper/wiper device.

The compaction device may comprise a platen lowerable onto the layer of material. The platen may achieve compaction by vibrating, or tamping. Alternatively, an ultrasonic vibration technique may be applied to achieve compaction before and/or during heating of the layer.

The use of such a device improves uniformity in the manufactured product by reducing the risk of the formation of regions of different density, and by reducing porosity.

The invention also relates to manufacturing methods using the devices described above.

This summary provides only a general outline of some embodiments of the invention. Many other objects, features, advantages and other embodiments of the invention will become more fully apparent from the following detailed description, the appended claims and the accompanying drawings

### DETAILED DESCRIPTION

This invention relates to a manufacturing device, and in particular to a device for use in an additive layer manufacturing technique, for example for use in the rapid manufacture of products or for use in rapid prototyping. It also relates to an associated manufacturing method.

The device illustrated in FIGS. 1 and 1a is intended for use in an additive layer manufacturing technique and comprises a bed 10 that is supported in such a manner as to allow it to be lowered in steps of a predetermined size. Immediately above the bed 10 is located a hopper/wiper device 12. The hopper/wiper comprises a pair of storage hoppers 14, 16 which, in this embodiment, are located in a fixed position, and a delivery hopper 18 which is movable from a position directly beneath the storage hoppers 14, 16 across the area immediately above the bed 10 to a deposition region 20.

Each of the storage hoppers 14, 16 includes a delivery means 22 operable to deliver material from the associated storage hopper 14, 16 to the delivery hopper 18. The delivery means 22 are controllable so as to permit a desired quantity of material to be delivered at any given time. The delivery means could take a wide range of forms, but in the arrangement illustrated comprises a rotatable shaft 24 formed with a series of pockets in the form of elongate recesses or grooves 25. The rotatable shaft 24 is arranged to be driven for rotation by an associated stepper motor or other drive device (not shown).

The delivery hopper 18 includes a similar delivery means 26 and, in addition, carries a wiper member 30 in the form of a blade held at a predetermined height.

A heating device or other energy input source is provided to permit heating of selected parts of the area immediately above the bed 10 in use. In the illustrated embodiment, the source takes the form of a laser device 32, but it will be appreciated that this need not always be the case and that, for example, electron beams could be used.

In use, the storage hoppers 14, 16 are filled with different materials to be used in the manufacture of a product. In order to commence manufacture, the bed 10 is moved to an upper position in that a height spaced below the wiper 30 by a predetermined amount. The delivery means 22 associated with the storage hopper 14 is driven for rotation to deliver a predetermined quantity of material from the storage hopper 14 to the delivery hopper 18. It will be appreciated that a predetermined quantity, governed by the size and layout of the grooves 25, of material will be delivered per rotation of the shaft, thus a good level of control over the quantity of material delivered can be achieved by appropriate control over the stepper motor used to drive the shaft 24 for rotation. Likewise, the delivery means 22 associated with the storage hopper 16 is operated to deliver a predetermined quantity of material from the storage hopper 16 to the delivery hopper 18. Conveniently, the operation of both delivery means 22 occurs simultaneously such that the material falling from the first and second hoppers 14, 16 to the delivery hopper 18 mixes to form a blended material. The total quantity of material delivered to the delivery hopper 18 is preferably substantially equal to the quantity of material required to form a single layer of the product.

After delivery of the material from the storage hoppers 14, 16 to the delivery hopper 18, the delivery hopper 18 is driven to the deposition region 20. Once this position is reached, the delivery means 26 associated therewith is driven for rotation to transfer the blended material from the hopper 18 to the region 20. Once the delivery hopper 18 has been emptied in this manner, the delivery hopper 18 is driven back to the position illustrated, the wiper 30 serving to spread the material from the region 20 over the bed 10, any excess material being carried away by the wiper 30 to a waste collection region 34. It will be appreciated that the spacing of the bed 10 below the wiper 30 results in the wiper 30 forming a layer of material of substantially uniform thickness on the bed 10.

After formation of the layer of substantially uniform thickness on the bed 10, the laser device 32 is operated to heat selected parts of the layer, causing melting thereof thereby forming solid regions within the layer, upon subsequent cooling After all of the desired parts of the layer have been heated in this manner the bed 10 is lowered by a predetermined distance equivalent to the thickness of one of the layers and the process is repeated. Repetition of the process results in a series of layers being built up and, eventually, in the entire product having been manufactured. After completion of this process, the manufactured product is removed from the bed 10. It will be appreciated that the parts of the various layers which have not been heated remain in powder form and can be easily removed from the final product.

In accordance with the invention, the blend of material used in each layer can, if desired, be different from the blend of material used in each adjacent layer by appropriate control over the operation of the delivery means 22 associated with each of the storage hoppers 14, 16. As a result, the composition of the final product can be selected by the user. A wide range of products can therefore be manufactured in a simple and convenient manner. For example material characteristics or properties of the product need not be uniform throughout the product but rather the product may be of, for example, different mechanical strengths in different parts thereof.

Although the arrangement illustrated uses only two storage hoppers 14, 16, it will be appreciated that the invention is also applicable to arrangements including three or more such hoppers, thereby permitting further increases in the range of products which can be manufactured.

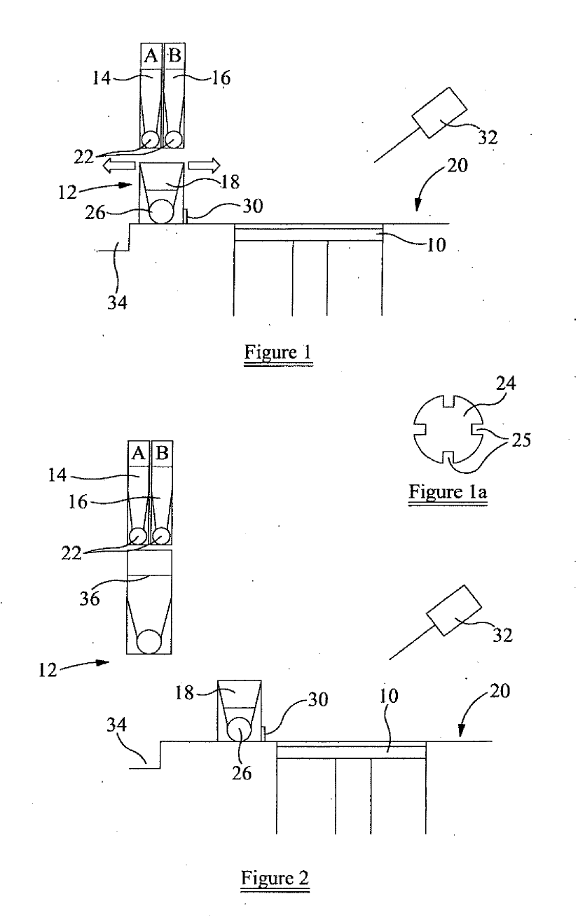

FIG. 2 illustrates an arrangement which is similar to that illustrated in FIG. 1 but in which an additional mixing hopper 36 is interposed between the storage hoppers 14, 16 and the delivery hopper 18. The provision of the mixing hopper 36 is advantageous in that thorough mixing or blending of the material can be ensured. Although not illustrated, the mixing hopper 36 may incorporate suitable mixing or agitation devices to assist in insuring that the material contained therein is fully mixed.

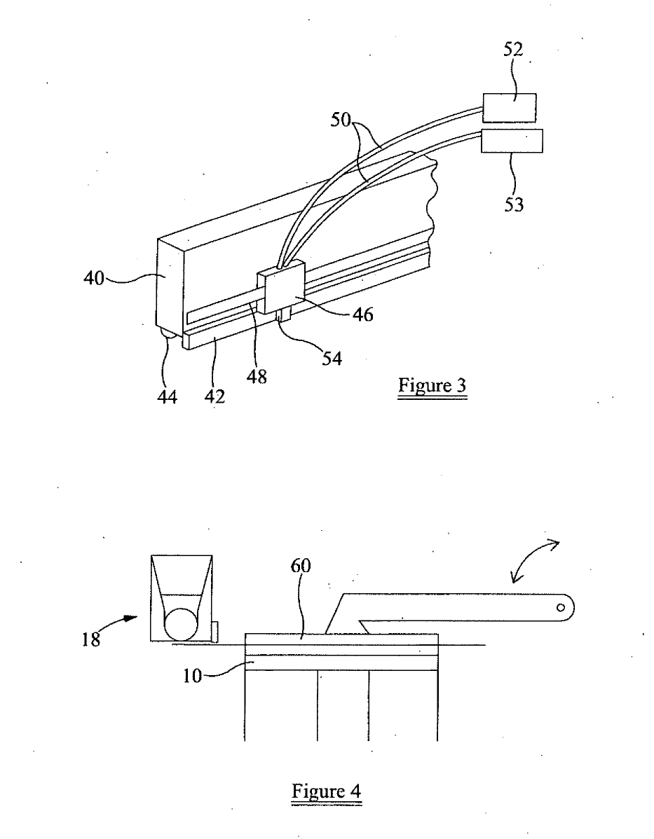

Referring next to FIG. 3 there is illustrated an arrangement in which each layer may include some regions of a first material and other regions of a second material. The device illustrated in FIG. 3 comprises a delivery hopper 40 similar to the delivery hopper 18 of the arrangement of FIG. 1, the delivery hopper 40 being provided with a wiper 42 and a delivery means 44 both of forms similar to that illustrated and described with reference to FIG. 1. The hopper 40 is movable across a bed in a manner similar to that illustrated and described with reference to FIG. 1, the drive means used in driving the hopper 40 for movement taking the form of a stepper motor or other incremental drive arrangement to permit accurate control over the position of the hopper 40 across the bed.

Secured to the hopper 40 is a second delivery device 46. The second delivery device 46 is movable transversely of the hopper 40 by a drive means 48 which permits accurate control of the position of the delivery device 46 relative to the hopper 40. The second delivery device 46 is connected by a flexible tubing 50 to a suction device 52 and to a metering device 53. The delivery device 46 further includes a delivery head 54 connected to the tubing 50 and which, in this embodiment, is positioned at a height very slightly above the bottom edge of the wiper 42. Other arrangements are possible in which the head 54 is otherwise located, either in front of or behind the wiper 42, and it may be desired to provide a separate wiper or other leveling device to level material delivered by the head 54, in use. In use, the device is operated in a manner similar to that described with reference to FIG. 1 to deliver a layer of a first material from the hopper 40 on to the bed. After formation of the layer, the hopper 40 is moved back over the layer until it occupies a position in which it is desired to apply a second material. Once this position of the hopper has been reached, the second delivery device 46 is moved transversely of the hopper 40 to position the head 54 at the location at which the second material is required. Once this position has been attained, the suction device 52 is operated to remove material from the layer in that location and, after removal of the material, the delivery metering device 53 is operated to deliver a metered quantity of a second material through the head 54 to that position on the bed. This procedure is repeated until all parts of the layer in which the second material is required have been treated in this manner. After delivery of the second material to all of the desired parts of the layer, the hopper 40 is moved away from the bed and the desired parts of the layer are heated using the laser device as described hereinbefore. The process is then repeated until the entire product has been built up.

It will be appreciated that the use of the arrangement illustrated and described with reference to FIG. 3 allows each layer to include regions of a first material and regions of a second material. If required, the device may be further modified to allow one or more further materials to be applied. It will be understood that such an arrangement permits great flexibility over the products which can be manufactured.

If desired, prior to removal of the first material from selected regions, a spray technique or other technique may be used to fix or adhere the required material against accidental removal or laser treatment.

In an alternative mode of operation, the steps of removing and replacing the first material may take place after heating of the desired regions of the layer. Such an arrangement permits a reduction in the level of accuracy with which the removal of the first material must be performed. If desired, further materials may be applied in similar operations, if desired.

Although in the arrangement described hereinbefore with reference to FIG. 3 the head 54 is mounted upon the hopper 40 for movement transverse thereto, the head 54 may be mounted independently of the hopper 40, if desired.

FIG. 4 illustrates a modification to the arrangements described hereinbefore to permit compaction of the layers prior to selective melting thereof. As illustrated in FIG. 4, a platen 60 is provided, the platen 60 being lowerable, after the formation of each layer, on to the layer prior to heating thereof by the laser device. The lowering of the platen 60 on to the layer in this manner allows compaction of the material or materials thereof to ensure that the material is of substantially uniform density and to avoid the formation of porous regions therein. Once the platen 60 has been lowered on to the layer, the compaction may arise simply due to the weight of the platen 60. Alternatively, or additionally, a motor or other means may be provided to cause the platen 60 to vibrate to assist in compaction. Other compaction techniques are also possible. For example ultrasonic techniques may be used, or the platen may be arranged to repeatedly tamp the surface of the layer. After compaction in this manner, the platen 60 is lifted or otherwise removed and the layer, or selected parts thereof, heated using the laser device prior to lowering of the bed in readiness for the delivery of a subsequent layer of material thereto. In an alternative operating mode, ultrasonic or similar vibrations may be applied during the laser melting process to encourage the molten material to flow which, again, may reduce porosity. This alternative may be used in addition to or instead of the techniques outlined hereinbefore.

It will be appreciated that the use of the platen to improve the uniformity of the density of the layer may additionally serve to improve the smoothness and uniformity of the layer thickness. This may have additional benefits in that it may then enhance the smoothness of the upper surface of each layer which may reduce wear of the associated wiper.

It will be appreciated that the techniques described hereinbefore may, if desired, be used in combination. For example the platen 60 may be used in the arrangements of FIGS. 1 to 3, if desired. Further, the arrangement of FIG. 3 may incorporate the invention of FIGS. 1 and 2, if desired to introduce variations into the blends of the first and second materials between layers.

A range of other modifications and alterations to the arrangements described hereinbefore may be made without departing from the scope of the invention.

In conclusion, the invention provides novel systems, devices, methods and arrangements for manufacturing devices and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A manufacturing device comprising a hopper/wiper device operable to apply layers of material to a bed, and heater means operable to heat selected areas of each layer to form a product, wherein the hopper/wiper device is operable so that the product includes at least a first part of a first material or material blend and a second part of a second material or material blend.

2. A device according to claim 1, wherein the hopper/wiper device is operable to permit control over the material or material blend of each layer.

3. A device according to claim 2, wherein the hopper/wiper device comprises a delivery hopper, at least first and second storage hoppers, and delivery means associated with each storage hopper to deliver a controllable quantity of material therefrom to the delivery hopper.

4. A device according to claim 3, further comprising a mixing hopper interposed between the storage hoppers and the delivery hopper to assist in ensuring full mixing of the material.

5. A device according to claim 3, wherein the delivery means comprises a rotatable shaft in which pockets are formed, and drive means operable to rotate the shaft.

6. A device according to claim 5, wherein the drive means comprises a stepper motor.

7. A device according to claim 5, wherein the pockets comprise elongate grooves formed in the shaft.

8. A device according to claim 1, wherein different parts of some of the layers are formed from different materials.

9. A device according to claim 8, wherein the hopper/wiper comprises a hopper movable to deliver of a layer of a first material, and means operable to remove the first material and introduce a second material in its place.

10. A device according to claim 9, wherein the hopper is movable in a first direction, and the removing and introducing means is movable in at least a second, perpendicular direction.

11. A device according to claim 10, wherein the removing and introducing means is carried by the hopper.

12. A device according to claim 10, wherein the hopper and the removing and introducing means are independently mounted.

13. A device according to claim 9, where the first material is removed using a vacuum removal technique.

14. A device according to claim 9, wherein an Archimedes screw arrangement is used in the introduction of the second material.

15. An additive layer manufacturing method comprising applying a layer of a first material, removing the first material from selected areas of the layer and replacing the removed material with a second material.

16. A method according to claim 15, and performed using a manufacturing device comprising a hopper/wiper device operable to apply layers of material to a bed, and heater means operable to heat selected areas of each layer to form a product, wherein the hopper/wiper device is operable so that the product includes at least a first part of a first material or material blend and a second part of a second material or material blend.

17. An additive layer manufacturing device comprising a hopper/wiper device operable to deliver a layer of material, and a compaction device operable to compact the layer of material delivered by the hopper/wiper device.

18. A device according to claim 17, wherein the compaction device comprises a platen lowerable onto the layer of material.
